(19) United States
(12) Patent Application Publication
(10) Pub. No.: US 2023/0208664 A1
(43) Pub. Date: Jun. 29, 2023

(54) MONITORING OF VIDEO CONFERENCE TO IDENTIFY PARTICIPANT LABELS

(71) Applicant: Lenovo (Singapore) Pte. Ltd., Singapore (SG)

(72) Inventors: John C. Mese, Cary, NC (US); Mark Delaney, Raleigh, NC (US); Nathan Peterson, Oxford, NC (US); Arnold Weksler, Raleigh, NC (US); Russell Speight VanBlon, Raleigh, NC (US)

(21) Appl. No.: 17/560,250

(22) Filed: Dec. 23, 2021

(51) Int. Cl. H04L 12/18; G10L 15/26; G10L 15/08; G06F 3/0482; H04N 7/15

(52) U.S. Cl. CPC H04L 12/1831; G10L 15/26; G10L 15/083; G06F 3/0482; H04N 7/152; H04N 7/155

(57) ABSTRACT

In one aspect, a device may include at least one processor and storage accessible to the at least one processor. The storage may include instructions executable by the at least one processor to monitor participation in a video conference and, based on the monitoring of participation, identify an identifier related to a first participant of the video conference. The instructions may also be executable to, based on the identifying of the identifier, present a graphical representation of the identifier on a display along with video showing the first participant participating in the video conference.

### FIELD

The disclosure below relates to technically inventive, non-routine solutions that are necessarily rooted in computer technology and that produce concrete technical improvements. In particular, the disclosure below relates to techniques for monitoring a video conference to identify labels for participants.

### BACKGROUND

As recognized herein, online meetings present a different dynamic and set of challenges than in-person meetings. As such, often times a video conferencing service might provide generic data about meeting participants based on whatever data the respective participant may have provided (or not) to the conferencing system itself beforehand. This data can therefore be limited, may not be available at all, and even then, can be dependent on static generic defaults set by the conferencing system itself that may not be all that useful to another participant or the video conference at hand. There are currently no adequate solutions to the foregoing computer-related, technological problem.

### SUMMARY

Accordingly, in one aspect a device includes at least one processor and storage accessible to the at least one processor. The storage includes instructions executable by the at least one processor to monitor participation in a video conference and, based on the monitoring of participation, identify information related to a first participant of the video conference. The instructions are also executable to, based on the identifying of the information, present an overlay on a display with video showing the first participant participating in the video conference. The overlay indicates a suggested label for the first participant.

In some examples, the monitoring of the participation in the video conference may include using words spoken during the video conference to identify the information. E.g., the instructions may be executable to execute voice recognition using input from a microphone to identify the spoken words to use the spoken words to identify the information. Additionally, or alternatively, the instructions may be executable to use, to identify the information, words spoken during the video conference as identified from a transcript of at least part of the video conference.

Also in some examples, the instructions may be executable to identify the information based on a name spoken during the video conference and matching the name to the information as in stored data accessible to the at least one processor. E.g., the stored data may include organizational information related to a particular organization to which the first participant belongs, and the suggested label may indicate the particular organization. Additionally, or alternatively, the stored data may include contact information for the first participant, and the suggested label may indicate the contact information.

Still further, if desired the video conference may be a first video conference, and the instructions may be executable to identify the first participant based on the monitoring of participation and to access data related to the first participant. The data may establish at least part of the information, and the data may indicate a topic related to a second video conference that transpired prior to the first video conference and/or a title for the first participant as identified from the second video conference.

Still further, in some example implementations the suggested label may be determined based on the information and a predetermined format for the suggested label.

Also in some example implementations, the instructions may be executable to, based on the identifying of the information, present a graphical user interface (GUI) on the display. The GUI may indicate the suggested label for the first participant. The instructions may also be executable to, based on user input to the GUI selecting the suggested label, present the overlay on the display with the video showing the first participant participating in the video conference.

Thus, the GUI may be presented responsive to identifying the information. Additionally, or alternatively, the GUI may be a first GUI and the first GUI may be presented based on the information and responsive to user input to an element presented on a second GUI different from the first GUI.

Also note that in various examples the GUI may include a selector that is selectable to provide the user input.

Also in various examples, the GUI may be a first GUI and the instructions may be executable to present a second GUI on the display. The second GUI may include an option for an end user different from the first participant to indicate a second label for the first participant, where the second label may be stored for use in a second video conference to occur in the future. So, for example, the instructions may be further executable to present a third GUI on the display during the second video conference, where the third GUI may present the second label as an overlay with video showing the first participant participating in the second video conference. The second GUI may be the same as or different from the first GUI.

In another aspect, a method includes monitoring participation in a video conference and, based on the monitoring of participation, identifying information related to a first participant of the video conference. The method also includes, based on the identifying of the information, presenting a graphical user interface (GUI) on a display. The GUI indicates a suggested identifier for the first participant. The method also includes, based on user input to the GUI selecting the suggested identifier, presenting a graphical element on the display along with video showing the first participant participating in the video conference. The graphical element indicates the identifier.

Thus, in some examples the method may include identifying a name and title spoken during the video conference as the information, where the identifier may indicate the name and title.

In still another aspect, at least one computer readable storage medium (CRSM) that is not a transitory signal includes instructions executable by at least one processor to monitor participation in a video conference and, based on the monitoring of participation, identify an identifier related to a first participant of the video conference. The instructions are also executable to, based on the identifying of the identifier, present a graphical representation of the identifier on a display along with video showing the first participant participating in the video conference.

In certain examples, the identifier may be identified from a transcript of speech from the video conference, where the speech may occur prior to a second participant logging on to the video conference. In these examples, the graphical representation may be presented to the second participant via the display.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIGS. 3-7 show various example graphical user interfaces (GUIs) that may be presented during video conferencing to overlay one or more participant labels consistent with present principles;

FIG. 8 illustrates example logic in example flow chart format that may be executed by a device consistent with present principles; and

FIG. 9 shows an example settings GUI that may be presented on a display to configure one or more settings of a device/conferencing system to operate consistent with present principles.

### DETAILED DESCRIPTION

Among other things, the detailed description below discusses use of a software agent to monitor meeting participation during a video conference between two or more participants and to identify labels to accompany one or more of the participants.

This can be accomplished through different mechanisms, such as detecting information during an introduction. For example, since in the beginning of a meeting participants might provide a brief introduction of themselves and their role to others, the agent may monitor the real-time audio or transcribed text and extract a label. The label may be surfaced to the end user via a notification offering to include the detected label for the respective participant or may be available as a “passive” option such as if a user clicks on a new “Set label . . . ” option. In some examples, information from a transcript, audio recording, or audio/video recording of a conference (or part thereof) that has already transpired may be parsed to identify a label (e.g., retroactively).

As another example, organization or contact information may be retrieved and used as labels. Thus, for example, conference participants from within the same company may have access to org info and contact info like an email address. This info may be parsed to also suggest a label such as a name, organization title, job title, and email address.

Still further, meeting participation history may be recorded for presenting labels in the future. For example, a common or familiar point of reference for a first participant may be a meeting that the first participant and a second participant were in or are in frequently, such as a recurring technology brainstorming meeting that happens each workweek. Thus, the label may indicate that other meeting or the relationship of the first participant to the second participant (e.g., “we have weekly meetings”).

Also in some examples, the system may allow for custom tags/labels where a user can customize another attendee's name so that when the two are in a meeting again, the customized label about that other attendee may be accessed and presented to the user.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM, or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI and includes programmable logic components programmed to perform the functions of an embodiment as well as general-purpose or special-purpose processors programmed with instructions to perform those functions.

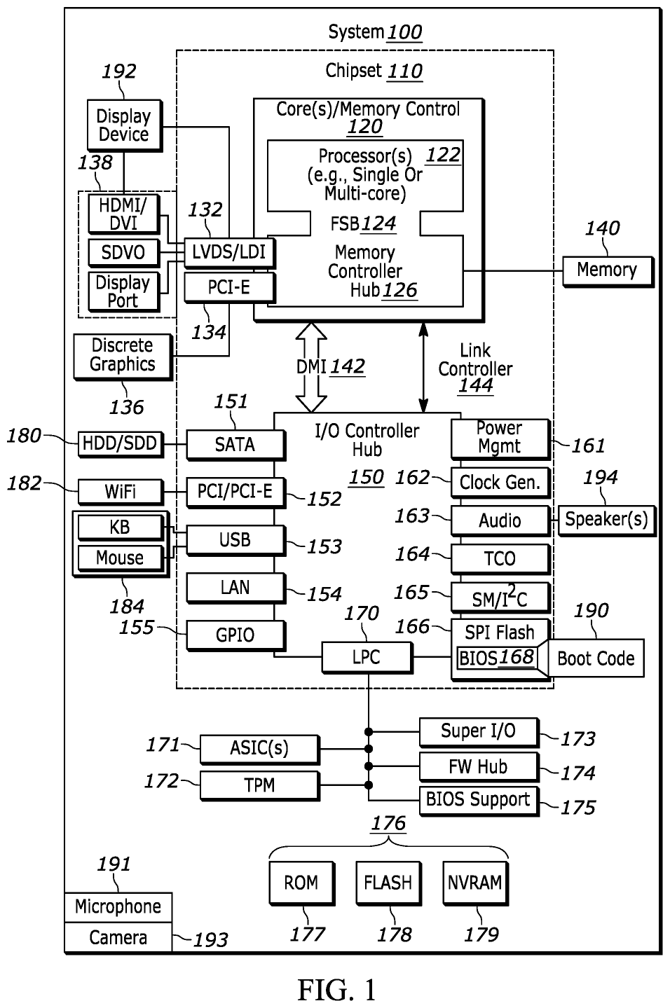

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing, or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, the system 100 may include an audio receiver/microphone 191 that provides input from the microphone 191 to the processor 122 based on audio that is detected, such as via a user providing audible input to the microphone 191 as part of a video conference consistent with present principles. The system 100 may also include a camera 193 that gathers one or more images and provides the images and related input to the processor 122. The camera 193 may be a thermal imaging camera, an infrared (IR) camera, a digital camera such as a webcam, a three-dimensional (3D) camera, and/or a camera otherwise integrated into the system 100 and controllable by the processor 122 to gather still images and/or video (e.g., for video conferences as disclosed herein).

Additionally, though not shown for simplicity, in some embodiments the system 100 may include a gyroscope that senses and/or measures the orientation of the system 100 and provides related input to the processor 122, as well as an accelerometer that senses acceleration and/or movement of the system 100 and provides related input to the processor 122. Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

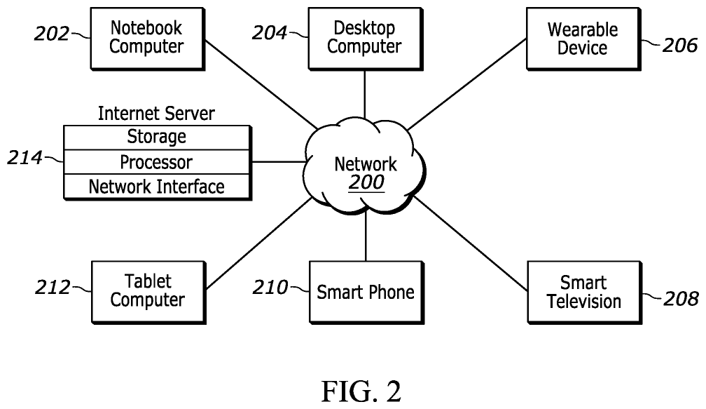

Turning now to FIG. 2, example devices are shown communicating over a network 200 such as the Internet in accordance with present principles (e.g., to exchange audio/video (AV) data as part of a video conference amongst various participants). It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles related to video conferencing/video calls.

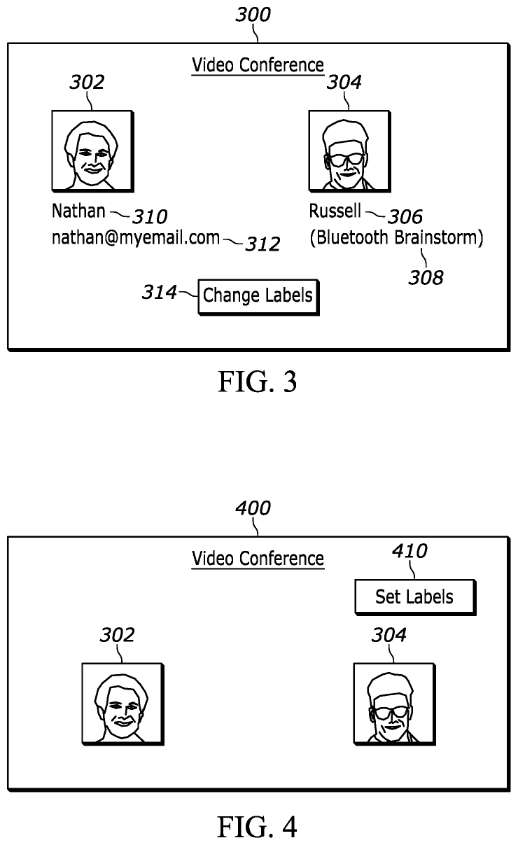

Now in reference to FIG. 3, suppose an end-user named John is participating in a video conference with two other participants named Nathan and Russell. Also assume that the video conference began with each participant orally introducing themselves. Consistent with present principles, the conferencing system's software as executing at one or more of the end users' own client devices (and/or a remotely-located coordinating server) may monitor voice input from each participant as provided to a respective microphone on that respective participant's own client device. The voice input may be monitored to execute voice recognition to determine, from the real time audio, names and other identifiers spoken by each participant during their respective introduction. Additionally, or alternatively, natural language processing (NLP) may be executed using a transcript of the introductions to determine the names and other identifiers spoken by each participant.

Either way, FIG. 3 shows a graphical user interface (GUI) 300 that may be presented on a display of John's device during or after the introductions. The GUI 300 may show a real time video stream 302 of Nathan and a real time video stream 304 of Russell, as may be presented while real time audio from each of those participants' device is also presented through speakers on John's device. In some examples, the real time video streams may be initially presented by themselves, or with accompanying generic or other static information about each participant. Then based on the determination(s) referenced in the paragraph above or other ones discussed further below, the GUI 300 may add dynamically-determined labels/identifiers for each participant as overlays/graphical elements beneath each participant's respective video stream 302, 304.

As one example, during his introduction Russell may have stated his name, and as such a name label 306 may be presented that indicates Russell's verbally-stated name (e.g., which may be different from an assigned or stored name). Note that while Russell may have stated his first and last name, only the first name has been presented, though in other embodiments both names may be presented.

The conferencing system may have also looked up other data based on the identification of Russell's name from his verbal introduction, including that Russell participated in a past conference with John where the topic was “Bluetooth technology brainstorming.” As such, another label 308 may also be included for Russell that indicates that Russell and John both participated in that past conference. In the present example, the label 308 indicates “Bluetooth brainstorm” as an abbreviation based on the topic or title of the past conference itself as stored by the system. Note here that the stored data itself that gets looked up may be stored in persistent storage at a remote-located server. Or the data may be stored in persistent storage at John's own device or at another location.

Regarding Nathan, during his introduction Nathan may have stated his name as well, and as such a name label 310 may be presented that indicates Nathan's verbally-stated name. Additionally, here too the conferencing system may have also looked up other data based on the identification of Nathan's name from his verbal introduction, and here that data includes contact information as indicated via a contact information label 312. In the present example, the contact information label 312 includes an email address for Nathan as may have been identified by the system from organizational information related to a particular organization to which Nathan belongs based on accessing that organizational information from wherever it is electronically stored and locating the contact info as already associated with Nathan's name. The organization may be, for example, a company or other business with which Nathan is employed, a service organization, a professional organization or networking group, etc. Also note that the contact information may include other contact info such as office location or address, phone number, facsimile number, etc. and further note that the organizational information might indicate other data besides just contact info that can still be included on a label for Nathan (such as Nathan's title within the company or another job description).

Still in reference to FIG. 3, in some examples the GUI 300 may also include a selector 314. The selector 314 may be selectable based on touch input, cursor input, or other input for John to provide user input to add or change the labels 306-312 already presented on the GUI 300. For example, John may wish to rename Russell according to a nickname John already knows for Russell, or may wish to add a job description for Nathan that John prefers.

Now in reference to FIG. 4, note that in other examples where the conferencing system is not set to autonomously provide determined labels for the various conference participants as reflected in FIG. 3, the GUI 400 of FIG. 4 may instead be presented during the video conference. As shown, the GUI 400 may still include the video streams 302, 304. But as also shown in FIG. 4, the GUI 400 may include a selector 410 or other graphical element that may be selectable by John to command the system to present suggested labels for Russell and Nathan. Note that the selector 410 may be presented at any time during the video conference (e.g., for John to indicate his own labels for Russell and Nathan or to view suggested labels), or in certain examples the selector 410 may be dynamically presented as part of the GUI 400 responsive to the conferencing system dynamically determining one or more labels consistent with present principles.

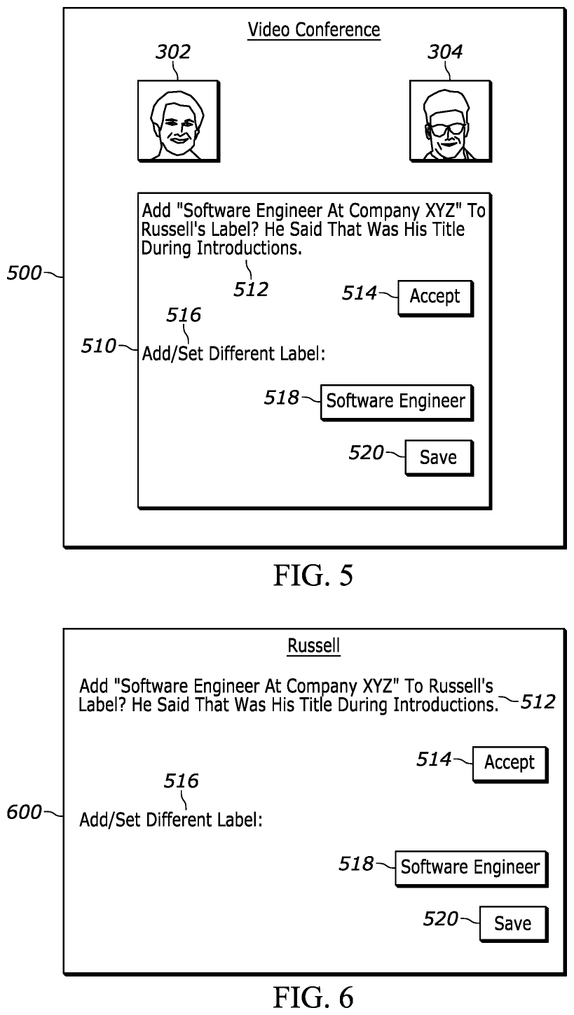

Then, once the selector 410 has been selected, the GUI 500 of FIG. 5 may be presented. However, further note that in other examples the GUI 500 may also be presented by the conferencing system/John's device autonomously responsive to the system/device determining information that may be included on one or more labels.

Regardless, as shown in FIG. 5 the GUI 500 may still include the video streams 302, 304 but may also include an overlay or window 510 as well. As shown, the overlay 510 may include a prompt 512 suggesting that John may wish to add “software engineer at company XYZ” as a label for Russell for presentation during the ongoing video conference. In some examples, as shown the prompt 512 may also indicate how the suggested label was determined, in this case based on Russell verbally indicating “software engineer at company XYZ” during his verbal introduction. If the user (John) wishes to accept the suggested label and include it beneath the stream 304 (or at another location for association with Russell), the user may select the selector 514 that is presented as part of the overlay 510 to select the suggested label.

Additionally, in some examples the overlay 510 may include an additional prompt 516 for the user to add an additional label for Russell or set a different label for Russell other than “software engineer at company XYZ”. To do so, the user may select and then direct alphanumeric input to input box 518 (e.g., using a hard or soft keyboard) to add to Russell's label as determined by the system (e.g., as auto-populated into the box 518) or to replace the label the system determined. Then once the desired labels have been set via the box 518, the user may select the save selector 520 to save the labels so that they may be used for the current video conference and even for future video conferences. In terms of future video conferences, the labels input by the user (John) may be used for future conferences in which Russell participates using the same conferencing system (or any conferencing system) regardless of whether John also participates or not. However, in other examples, the labels input by John may only be presented to John in future conferences in which Russell and John are both participants. Thus, in the latter example the labels John provides may be specific and tailored to John's own participation in video conferences in which Russell also participates (and only presented to John and not other participants of the future conference).

However, further note that in some examples the GUI 500 may not include the prompt 516, box 518, and selector 520 (even if it includes other elements from the overlay 510 described above) but may instead include a change selector similar to the selector 314 described above. Then responsive to selection of such a selector, the GUI 600 of FIG. 6 may be presented. As shown in that figure, the GUI 600 may include some or all of the elements described above in reference to FIG. 5. Thus, for example, the device might autonomously prompt the user with the GUI 500 but without the prompt 516, box 518, and 520, and then the user may either accept the suggested labels for overlay as part of the video conference presentation or select a change labels selector to present a different GUI from which other labels may be set (the GUI 600).

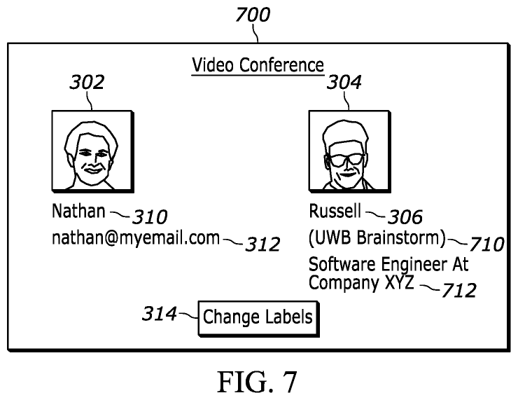

Then as shown in FIG. 7, once suggested labels have been accepted and/or additional labels specified by the user have been provided as described above, a GUI 700 may be presented on the display of John's device during the same video conference with Nathan and Russell. As shown, the GUI 700 still includes the labels 310, 312 as overlays associated with Nathan as well as the label 306 as an overlay associated with Russell. The GUI 700 may also include the change labels selector 314 should the user wish to make further additions or changes to the labels.

But contrasting the GUI 700 with the GUI 300, a label 710 is also now presented as an overlay associated with Russell's video stream 304 based on the user (John) editing the label 308 through a GUI like the GUIs 500 or 600 to transform it to the label 710. In the present instance, the label 710 indicates “UWB brainstorm” rather than “Bluetooth brainstorm”.

FIG. 7 further shows that another label 712 has also been added to the GUI 700 as an overlay, either based on John as using a GUI like the GUIs 500 or 600 to provide a job title and company name for Russell or based on the conferencing system itself identifying as much from a verbal introduction or other data as also described above.

Also note before moving on that the labels 310, 312, 306, 710, and 712 may also be saved and used for video conference GUIs for future video conferences as also described above.

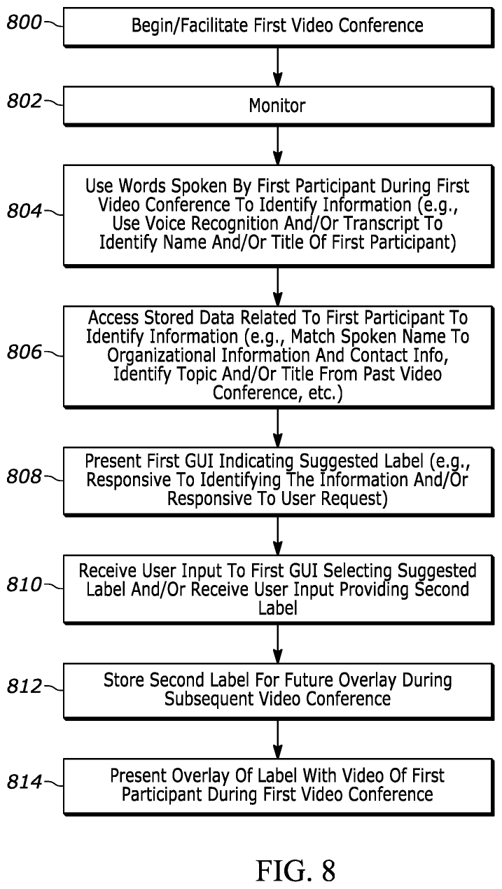

Referring now to FIG. 8, it shows example logic that may be executed by a device such as the system 100, an end-user's device like John's client device per the example above, and/or a server coordinating video conferencing/hosting a video conferencing system in any appropriate combination consistent with present principles. Note that while the logic of FIG. 8 is shown in flow chart format, other suitable logic may also be used.

Beginning at block 800, the device may begin facilitating a first video conference by, e.g., transmitting AV data between client devices consistent with present principles, including real time video of one or more conference participants and real time audio data of one or more conference participants. Metadata may also be exchanged, where the metadata may include any labels already determined for the various participants. Also note that metadata exchanged later but still during the first video conference may also indicate other labels as dynamically determined based on user input and/or device determinations as described above. From block 800 the logic may proceed to block 802.

At block 802 the device may monitor participation in the first video conference to, at block 804, identify information related to one or more participants of the first video conference using words spoken during the first video conference. For example, at block 802 the device may receive one or more microphone streams of audio of respective participants. Voice recognition may then be executed on the streams to, at block 804, identify the spoken words to then identify the information for the respective participant from the spoken words (such as a name of a first participant). As another example, at block 802 the device, to identify the information, may use words spoken during the first video conference as identified from a transcript of at least part of the first video conference as may also be generated by the system using speech to text software. In either case, natural language processing (NLP) may be used to extract the labels from the spoken words. Further note that while the spoken words might have been spoken during an introduction segment of the first video conference as described above, they may also have been spoken during other portions of the first video conference as well. And again, note that the information to be included as a label/overlaid identifier may include, as examples, first and last name of the respective participant, job title or organizational title of the respective participant, and other information consistent with present principles.

From block 804 the logic may proceed to block 806. At block 806 the device may access stored data related to at least the first participant to identify additional information related to the first participant. For example, at block 806 the device may identify the additional information based on a name of the first participant as spoken during the first video conference matching an entry in the stored data. E.g., the stored data may include organizational information and/or contact information for multiple different employees of a company along with the respective person's name, and so the name of the first participant as spoken by the first participant themselves may be used to parse the organizational/contact information by name and lookup additional information on the first participant. Social networking information and other data might also be accessed, such as the first participant's professional profile from LinkedIn from which other information may be extracted using NLP.

Additionally, note that the data related to the first participant that is accessed by the system may indicate a topic related to a second video conference that transpired prior to the first video conference, a title for the first participant as identified from the second video conference, and still other information from the second video conference if desired. This data may have been determined by the conferencing system during the second video conference for use as a label for the first participant (e.g., based on a transcript of the second video conference), and/or may have been provided by an end-user for use as a label for the first participant during the second video conference itself. For example, the topic may have been specified by an organizer of the second video conference when sending out electronic invites for the second video conference, and then saved by the system for future use.

From block 806 the logic may then proceed to block 808 to present a first GUI indicating a suggested label(s) (e.g., responsive to identifying the information for the label itself and/or responsive to a user request to present suggested labels). For example, at block 808 the logic may present one of the GUIs 300, 500, or 600 described above. Thereafter the logic may proceed to block 810.

At block 810 the device may receive user input to the first GUI selecting the suggested label(s) and/or receive user input providing additional labels such as a second label, as described above. From block 810 the logic may then proceed to block 812 where the device may store the second/additional labels for future overlay during subsequent video conferences as also discussed above. Thereafter the logic may proceed to block 814 where the device may present overlays of the labels for the first participant along with the real time video itself of the first participant during the first video conference.

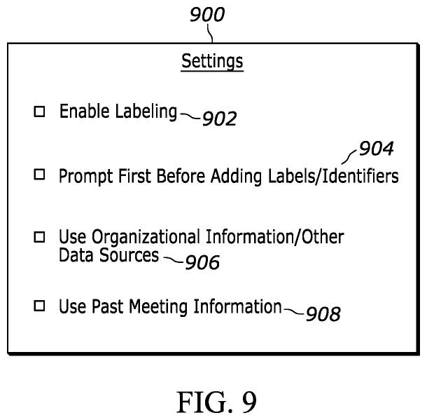

Continuing the detailed description in reference to FIG. 9, it shows another example GUI 900 that may be presented on a display of a device configured to undertake present principles. For example, the GUI 900 may be presented on a display of the device undertaking the logic of FIG. 8, a display of an end-user's own client device, or another display of another device such as a system administrator's device or coordinating server. The GUI 900 may be a settings GUI that may be presented to set or enable one or more settings of the device or conferencing system to operate consistent with present principles. For example, the GUI 900 may be reached by navigating a main settings menu of the device or its operating system, or a settings menu for a particular software application being used for video conferencing. Also note that in the example shown, each option discussed below may be selected by directing touch or cursor input to the respective check box adjacent to the respective option.

As shown in FIG. 9, the GUI 900 may include an option 902 that may be selectable a single time to set or configure the device to undertake present principles in multiple future instances, such as executing the functions described above in reference to FIGS. 3-7 and executing the logic of FIG. 8 for different video conferences in the future.

The GUI 900 may also include an option 904 that may be selectable to prompt an end-user during a video conference before adding labels/graphical representations of identifiers as overlays for the video conference. For example, the option 904 may be selected to set or configure the device to present the GUI 500 rather than autonomously presenting labels per FIG. 3 as also described above.

Additionally, if desired the GUI 900 may include an option 906 that may be selectable to specifically set or configure the device to access stored data to determine labels to suggest (in addition to identifying information from spoken words of the respective conference's participants). Again, note that the stored data may include organizational information related to a particular organization to which a participant belongs as described above.

Still further, in some examples the GUI 900 may include an option 908 that may be selectable to specifically set or configure the device to use past conference information, including any suggested or user-specified labels for the past video conferences, for presenting similar labels during subsequent video conferences as also described above.

Moving on from FIG. 9, it is to be further understood consistent with present principles that various labels may be suggested to a given participant of a video conference even if, for example, that participant is late to the conference and therefore that participant's device missed participant introductions that may have occurred at the beginning. So, for example, a given label/identifier may be identified from a transcript of the speech from the introduction stage of the video conference that occurred prior to the participant logging on to the video conference to still suggest one or more labels so that any labels/graphical representations of identifiers determined from the transcript may be presented to the late participant via a GUI like one of the ones discussed above after the late participant logs on to the video conference.

It is to also be understood that a suggested label may be determined responsive, at least in part, to a predetermined or predesignated label format associated with the context of the call and/or an organizer of the call. For example, if an organizer tutors others virtually via a particular video conferencing platform (tutoring being the context in this example) and does not wish for last names of participants to be presented as labels to others, the organizer may specify as much via a GUI like the GUI 900 (e.g., through a format field or box presented as part of the GUI). But since the same person may also use the same platform for another type of call (e.g., a work call, which may be another context per this example), the system may also autonomously switch to providing labels with last names of the participants for the work call. E.g., according to the second context the label for the organizer may be presented to others as “Steve Smith—Company X,” but according to the first context the label for the organizer may be presented to others as “Steve S.” or “Steve S., Tutor.”

It may now be appreciated that present principles provide for an improved computer-based user interface that increases the ease of use of the devices disclosed herein and their functionality to provide useful labels to various video conference participants. The disclosed concepts are thus rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged, or excluded from other embodiments.

1. A device, comprising:
at least one processor; and
storage accessible to the at least one processor and comprising instructions executable by the at least one processor to:
monitor participation in a video conference;
based on the monitoring of participation, identify information related to a first participant of the video conference; and
based on the identifying of the information and responsive to a second participant logging on to the video conference after the video conference has begun, present an overlay on a display with video showing the first participant participating in the video conference, the overlay indicating a label for the first participant, the second participant being different from the first participant.

2. The device of claim 1, wherein monitoring the participation in the video conference comprises:
using words spoken during the video conference to identify the information.

3. The device of claim 2, wherein the instructions are executable to:
execute voice recognition using input from a microphone to identify the spoken words to use the spoken words to identify the information.

4. (canceled)

5. The device of claim 1, wherein the instructions are executable to:
identify the information based on a name spoken during the video conference and matching the name to the information as in stored data accessible to the at least one processor.

6-7. (canceled)

8. The device of claim 1, wherein the video conference is a first video conference, and wherein the instructions are executable to:
based on the monitoring of participation, identify the first participant;
access data related to the first participant, the data establishing at least part of the information, the data indicating one or more of: a topic related to a second video conference that transpired prior to the first video conference, a title for the first participant as identified from the second video conference.

9. The device of claim 1, wherein the label is determined based on the information and a predetermined format for the label.

10-16. (canceled)

17. A method, comprising:
monitoring participation in a video conference;
based on the monitoring of participation, identifying information related to a first participant of the video conference;
based on the identifying of the information and responsive to a second participant logging on to the video conference after the video conference has begun, presenting a graphical user interface (GUI) on a display, the GUI indicating an identifier for the first participant along with video showing the first participant participating in the video conference, the first participant being different from the second participant.

18. (canceled)

19. At least one computer readable storage medium (CRSM) that is not a transitory signal, the computer readable storage medium comprising instructions executable by at least one processor to:
monitor participation in a video conference;
based on the monitoring of participation, identify an identifier related to a first participant of the video conference;
based on the identifying of the identifier and responsive to a second participant logging on to the video conference after the video conference has begun, present a graphical representation of the identifier on a display along with video showing the first participant participating in the video conference, the second participant being different from the first participant.

20. The CRSM of claim 19, wherein the identifier is identified from a transcript of speech from the video conference, the speech occurring prior to the second participant logging on to the video conference, the graphical representation being presented to the second participant via the display.

21. The CRSM of claim 19, wherein the instructions are executable to:
prior to the video conference, present a settings graphical user interface (GUI) on the display, the settings GUI comprising an option that is selectable a single time to set the at least one processor to, for multiple video conferences to occur in the future, present respective labels for respective participants of the multiple video conferences.

22. The device of claim 1, wherein the label includes an email address associated with the first participant.

23. The device of claim 1, wherein the label includes an office address associated with the first participant.

24. The device of claim 1, wherein the label includes a phone number associated with the first participant.

25. The device of claim 1, wherein the video conference is a first video conference, and wherein the label comprises data determined based on a verbal introduction of the first participant during a second video conference that transpired prior to the first video conference.

26. The device of claim 1, wherein the label includes social networking data associated with the first participant.

27. The device of claim 1, wherein the information is identified from a social networking profile associated with the first participant.

28. The device of claim 1, wherein the instructions are executable to:
identify the information related to the first participant based on execution of natural language processing (NLP) using words spoken by the first participant as part of the video conference.

29. The device of claim 1, wherein the instructions are executable to:
prior to the video conference, present a graphical user interface (GUI) on the display, the GUI comprising an option that is selectable a single time to set the device to, for multiple video conferences to occur in the future, present respective labels for respective participants of the multiple video conferences.

30. The method of claim 17, wherein the information is identified from a social networking profile associated with the first participant.

31. The method of claim 17, comprising:
prior to the video conference, presenting a graphical user interface (GUI) on the display, the GUI comprising an option that is selectable a single time to set a device facilitating the method to, for multiple video conferences to occur in the future, present respective labels for respective participants of the multiple video conferences.
